(19) United States
(12) Patent Application Publication
(10) Pub. No.: US 2006/0020064 A1
(43) Pub. Date: Jan. 26, 2006

(54) Flame-retardant polymer molding compositions

(75) Inventors: Harald Bauer, Kerpen (DE); Sebastian Hoerold, Diedorf (DE); Werner Krause, Huerth (DE); Martin Sicken, Koeln (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/182,693

(22) Filed: Jul. 15, 2005

(30) Foreign Application Priority Data
Jul. 22, 2004 (DE) 10 2004 035 508.8

(51) Int. Cl. C08K 5/49

(52) U.S. Cl. 524/115

(57) ABSTRACT

The invention relates to a flame-retardant polymer molding composition which comprises a nanoparticulate phosphorus-containing flame retardant system which comprises at least one phosphinic salt of the formula (I) and/or diphosphinic salt of the formula (II) and/or their polymers, 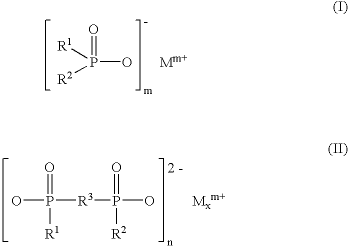 where
R¹ and R² are identical or different and are C₁-C₆-alkyl, linear or branched, and/or aryl;
R³ is C₁-C₁₀-alkylene, linear or branched, C₆-C₁₀-arylene, -alkylarylene, or -arylalkylene; M is Mg, Ca, Al, Sb, Sn, Ge, Ti, Fe, Zr, Zn, Ce, Bi, Sr, Mn, Li, Na, K, and/or a protonated nitrogen base; m is from 1 to 4; n is from 1 to 4; x is from 1 to 4.

The present invention is described in the German priority application No. 102004035508.8, filed 22.07.2004, which is hereby incorporated by reference as is fully disclosed herein.

The invention relates to flame-retardant polymer molding compositions, to a process for preparation of the same, and also to flame-retardant polymer moldings.

Nanocomposites of plastics with nanoparticulate fillers (nanofillers) exhibit exceptional improvements in properties due to their particular structure, inter alia an increase in stiffness and an improvement in the impact resistance of plastics moldings. Known nanofillers are organically modified phyllosilicates (bentonites, montmorillonites, hectorites, saponites, etc.).

A disadvantage is that these cannot alone achieve adequate flame retardancy, because they merely act as an inert substance.

There has therefore been no lack of attempts to stabilize flame-retardant polymers, too, with nanofiller and with this raise, by way of example, the glow-wire ignition temperature (GWIT). A disadvantage here is that the nanofiller acts as an inert substance and has to be used in addition to the flame retardant system. The result is an increase in the solids content of the flame-retardant polymer molding, and this in turn causes loss of mechanical elasticity properties.

Surprisingly, it has now been found that the glow-wire ignition temperature can be increased solely via use of a nanoparticulate flame retardant system. The organically intercalated phyllosilicate can therefore be omitted. The solids content of the flame-retardant polymer molding composition can thus be lowered. The results can be flame-retardant polymers and polymer moldings with markedly improved mechanical elasticity properties.

Surprisingly, it has also been found that the nanoparticulate phosphorus-containing flame retardant system used according to the invention increases light transmission in transparent plastics, when comparison is made with non-nanoparticulate phosphorus-containing flame retardant systems.

The invention therefore provides flame-retardant polymer molding compositions which comprise a nanoparticulate phosphorus-containing flame retardant system which comprises at least one phosphinic salt of the formula (I) and/or diphosphinic salt of the formula (II) and/or their polymers, 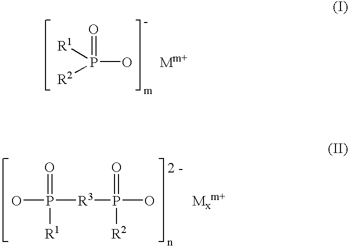
where
R¹ and R² are identical or different and are C₁-C₆-alkyl, linear or branched, and/or aryl; R³ is C₁-C₁₀-alkylene, linear or branched, C₆-C₁₀-arylene, -alkylarylene, or -arylalkylene; M is Mg, Ca, Al, Sb, Sn, Ge, Ti, Fe, Zr, Zn, Ce, Bi, Sr, Mn, Li, Na, K, and/or a protonated nitrogen base;
m is from 1 to 4; n is from 1 to 4; x is from 1 to 4.

R¹ and R², identical or different, are preferably C₁-C₆-alkyl, linear or branched, and/or phenyl.

Other preferred meanings of R¹ and R², identical or different, are methyl, ethyl, n-propyl, isopropyl, n-butyl, tert-butyl, n-pentyl and/or phenyl.

R³ is preferably methylene, ethylene, n-propylene, isopropylene, n-butylene, tert-butylene, n-pentylene, n-octylene, or n-dodecylene; phenylene or naphthylene; methylphenylene, ethylphenylene, tert-butylphenylene, methylnaphthylene, ethylnaphthylene, or tert-butylnaphthylene; phenylmethylene, phenylethylene, phenylpropylene, or phenylbutylene.

The particle size of the nanoparticulate phosphorus-containing flame retardant system is preferably from 1 to 1000 nm, particularly preferably from 5 to 500 nm.

The BET surface area of the nanoparticulate phosphorus-containing flame retardant system is preferably from 2 to 1000 m²/g, particularly preferably from 5 to 500 m²/g.

The nanoparticulate phosphorus-containing flame retardant system preferably comprises from 0.01 to 10% by weight of protective colloids and/or crystallization modifiers.

The flame-retardant polymer molding composition preferably comprises from 0.5 to 45% by weight of nanoparticulate phosphorus-containing flame retardant system, from 0.5 to 95% by weight of polymer or a mixture of these, where the entirety of the components is 100% by weight.

The flame-retardant polymer molding composition preferably comprises from 0.5 to 45% by weight of nanoparticulate phosphorus-containing flame retardant system, from 0.5 to 95% by weight of polymer or a mixture of these, from 0.5 to 55% by weight of additives, from 0.5 to 55% by weight of filler or of reinforcing materials, where the entirety of the components is 100% by weight.

The flame-retardant polymer molding composition preferably comprises from 10 to 40% by weight of nanoparticulate phosphorus-containing flame retardant system, from 10 to 80% by weight of polymer or a mixture of these, from 2 to 40% by weight of additives, from 2 to 40% by weight of filler or of reinforcing materials, where the entirety of the components is 100% by weight.

The polymer is preferably a thermoplastic or thermoset polymer.

The thermoplastic polymers are preferably HI (high-impact) polystyrene, polyphenylene ethers, polyamides, polyesters, polycarbonates, polyolefins, polyethers, and blends or polyblends of the type represented by ABS (acrylonitrile-butadiene-styrene) or PC/ABS (polycarbonate/acrylonitrile-butadiene-styrene), polyamide, polyester, polyarylates, polymethacrylates, and/or ABS.

The thermoset polymers are preferably formaldehyde, epoxy, melamine, or phenolic resin polymers, and/or polyurethanes.

The additive is preferably a nitrogen compound, phosphorus compound, or phosphorus-nitrogen compound.

The additive is preferably nitrogen compounds of the formulae (III) to (VIII), or a mixture thereof, 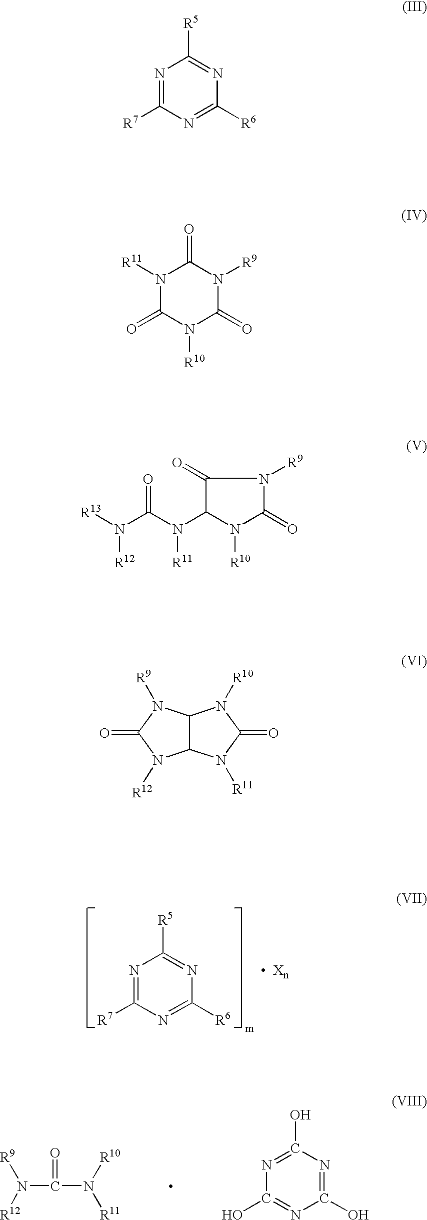
where
R⁵ to R⁷ are hydrogen, C₁-C₈-alkyl, C₅-C₁₆-cycloalkyl or -alkylcycloalkyl,
   optionally substituted with a hydroxy or a C₁-C₄-hydroxyalkyl function, C₂-C₈-alkenyl, C₁-C₈-alkoxy, -acyl, -acyloxy, C₆-C₁₂-aryl or -arylalkyl, —OR⁸, or —N(R⁸)R⁹, including systems of alicyclic-N or aromatic-N type,
R⁸ is hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl, C₁-C₈-alkoxy, -acyl, -acyloxy, or C₆-C₁₂-aryl or -arylalkyl,
R⁹ to R¹³ are the same as the groups for R⁸, or else —O—R⁸,
m and n, independently of one another, are 1, 2, 3, or 4,
X is acids which can form adducts with triazine compounds (III).

The additive is preferably nitrogen compounds such as melamine, melamine condensates, such as melam, melem, and/or melon; benzoguanamine, tris(hydroxyethyl) isocyanurate, allantoin, glycoluril, dicyandiamide, and/or guanidine.

Other preferred meanings of the additive are melamine phosphate, dimelamine phosphate, melamine pyrophosphate, melamine polyphosphates, melam polyphosphates, melem polyphosphates, and/or melon polyphosphates, and/or melamine cyanurate, and/or urea cyanurate.

Other preferred meanings of the additive are zinc compounds, such as zinc oxide, zinc hydroxide, zinc oxide hydrate, anhydrous zinc carbonate, basic zinc carbonate, zinc hydroxide carbonate, basic zinc carbonate hydrate, (basic) zinc silicate, zinc hexafluorosilicate, zinc stannate, zinc magnesium aluminum hydroxide carbonate, zinc hexafluorosilicate hexahydrate, zinc salts of the oxo acids of the third main group, e.g. zinc borate, zinc salts of the oxo acids of the fifth main group, e.g. zinc phosphate, zinc pyrophosphate, zinc salts of the oxo acids of the transition metals, e.g. zinc chromate(VI) hydroxide (zinc yellow), zinc chromite, zinc molybdate, zinc permanganate, zinc molybdate magnesium silicate, zinc permanganate.

Other preferred meanings of the additive are antimony compounds, such as antimony trioxide, antimony tetroxide, antimony pentoxide, sodium antimonate, and/or antimony tartrate.

Other preferred meanings of the additive are oligomeric esters of tris(hydroxyethyl) isocyanurate with aromatic polycarboxylic acids, or is carbodiimides, N,N′-dicyclohexylcarbodiimide, polyisocyanates, carbonylbiscaprolactam, styrene-acrylic polymers, sterically hindered phenols, and/or is nitrogen-containing phosphates of the formulae (NH₄)_{y}H_{3-y}PO₄ or (NH₄PO₃)_{z}, where y is from 1 to 3, and z is from 1 to 10 000, or is release agent.

Another preferred meaning of the additive is at least one compatibilizer.

The abovementioned additives may also be nanoparticulate, preferably in particle sizes of from 1 to 1000 nm.

The compatibilizer is preferably anhydride-modified oligomers or hydroxy-containing polyolefin oligomers, preferably polypropylene-maleic anhydride copolymer, polyvinylpyrrolidone, polyvinyl alcohol, polyethylene glycol, polytetrahydrofuran, polystyrene, polycaprolactone, organosilanes, and/or quaternary ammonium compounds.

In the case of polybutylene terephthalate molding compositions, the SV numbers are from 750 to 1400, particularly preferably from 950 to 1300, and in particular from 1000 to 1200.

In the case of glass fiber-reinforced flame-retardant polymer molding compositions based on nylon-6,6, the MVR value is preferably from 2 to 200 cm³/min (275° C., 5 kg).

The residual moisture level of the flame-retardant polymer molding compositions is preferably from 0.01 to 10% by weight, particularly preferably from 0.1 to 1% by weight.

The transparency of the flame-retardant polymer molding compositions is preferably from 70 to 100%.

The invention also provides a process for the preparation of the inventive flame-retardant polymer molding compositions, which comprises dispersing the phosphorus-containing flame retardant system into the polymer molding composition or polymers in a compounding assembly.

In another embodiment, the phosphorus-containing flame retardant system is dispersed with the polymer molding composition in polymers in a compounding assembly.

Further polymers, additives, auxiliaries, in particular dispersing agents, and/or compatibilizers, are preferably added during the abovementioned processes.

The compounding assemblies are preferably single- and twin-screw kneaders, co-kneaders, Brabender kneaders, calenders, or roll mills, including triple-roll mills.

The temperature is preferably from 50 to 150° C., the reaction time is preferably from 0.01 to 100 h, and the pressure is preferably from 1 to 200 MPa.

Amounts of from 0.01 to 10% by weight, particularly preferably from 1 to 5% by weight (based on nanoparticulate phosphorus-containing flame retardant system) of at least one compatibilizer are preferably added as additive.

The compatibilizer preferably comprises anhydride-modified oligomers or hydroxy-containing polyolefin oligomers, preferably polypropylene-maleic anhydride copolymer, polyvinylpyrrolidone, polyvinyl alcohol, polyethylene glycol, polytetrahydrofuran, polystyrene, polycaprolactone, organosilanes, and/or quaternary ammonium compounds.

The processing temperatures in the abovementioned process are preferably from 170 to 200° C. for polystyrene, from 200 to 300° C. for polypropylene, from 250 to 290° C. for polyethylene terephthalate (PET), from 230 to 270° C. for polybutylene terephthalate (PBT), from 260 to 290° C. for nylon-6 (PA 6), from 260 to 290° C. for nylon-6,6 (PA 6.6), from 280 to 320° C. for polycarbonate.

The L/D values for the screw kneader, co-kneader and/or extruder are preferably from 1 to 100, preferably from 2 to 50.

The shear rates for the compounding assembly are preferably from 10 sec⁻¹ to 20 000 sec⁻¹, particularly preferably from 100 sec⁻¹ to 10 000 sec⁻¹.

The invention also provides polymer moldings, polymer films, polymer filaments, and polymer fibers comprising a nanoparticulate phosphorus-containing flame retardant system which comprises a phosphinic salt of the formula (I) and/or diphosphinic salt of the formula (II), and/or their polymers, 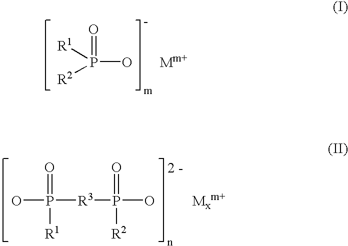
where R¹ and R² are identical or different and are C₁-C₆-alkyl, linear or branched, and/or aryl; R³ is C₁-C₁₀-alkylene, linear or branched, C₆-C₁₀-arylene, -alkylarylene, or -arylalkylene;
M is Mg, Ca, Al, Sb, Sn, Ge, Ti, Fe, Zr, Zn, Ce, Bi, Sr, Mn, Li, Na, K, and/or a protonated nitrogen base; m is from 1 to 4; n is from 1 to 4; x is from 1 to 4.

The polymer moldings, polymer films, polymer filaments, and polymer fibers preferably comprise
from 0.5 to 45% by weight of nanoparticulate phosphorus-containing flame retardant system,
from 0.5 to 95% by weight of polymer or a mixture of these.

The polymer moldings, polymer films, polymer filaments, and polymer fibers preferably comprise
from 0.5 to 45% by weight of nanoparticulate phosphorus-containing flame retardant system,
from 0.5 to 95% by weight of polymer or a mixture of these,
from 0.5 to 55% by weight of additives,
from 0.5 to 55% by weight of filler or of reinforcing materials.

The polymer moldings, polymer films, polymer filaments, and polymer fibers preferably comprise
from 10 to 40% by weight of nanoparticulate phosphorus-containing flame retardant system,
from 10 to 80% by weight of polymer or a mixture of these,
from 2 to 40% by weight of additives,
from 2 to 40% by weight of filler or of reinforcing materials.

The invention also provides polymer moldings, polymer films, polymer filaments, and polymer fibers comprising the inventive flame-retardant polymer molding compositions.

The polymer moldings, polymer films, polymer filaments, and polymer fibers here preferably comprise
from 60 to 98% by weight of flame-retardant polymer molding composition,
from 1 to 40% by weight of polymer or a mixture of these.

The polymer moldings, polymer films, polymer filaments, and polymer fibers here particularly preferably comprise
from 60 to 98% by weight of flame-retardant polymer molding composition,
from 1 to 40% by weight of polymer or a mixture of these,
from 0.2 to 40% by weight of additives,
from 0.2 to 40% by weight of filler or of reinforcing materials.
   In the case of polybutylene terephthalate or nylon-6,6 or nylon-6, the modulus of elasticity for the abovementioned polymer moldings, polymer films, polymer filaments, and polymer fibers is from 10 000 to 12 000 MPa.

The UL 94 classification of the polymer moldings is V-1 or V-0 for the abovementioned polymer moldings, polymer films, polymer filaments, and polymer fibers.

In the case of polybutylene terephthalate, the tensile strain at break for the polymer moldings, polymer films, polymer filaments, and polymer fibers is preferably from 1.3 to 3%, preferably from 1.9 to 2.2%.

In the case of polybutylene terephthalate, the impact resistance for the polymer moldings, polymer films, polymer filaments, and polymer fibers is preferably from 45 to 70 kJ/m², preferably from 55 to 62 kJ/m².

In the case of polybutylene terephthalate, the glow-wire temperature (glow-wire ignition test, GWIT) of the polymer moldings, polymer films, polymer filaments, and polymer fibers is preferably from 750 to 900° C., preferably from 775 to 875° C.

The transparency of the polymer moldings, polymer films, polymer filaments, and polymer fibers is preferably from 70 to 100%.

It is preferable that in the polymer moldings, polymer films, polymer filaments, and polymer fibers, the particle size of the nanoparticulate phosphorus-containing flame retardant system is from 1 to 1000 nm, preferably from 5 to 500 nm, and/or the BET surface area of the nanoparticulate phosphorus-containing flame retardant system is from 2 to 1000 m²/g, preferably from 5 to 500 m²/g, and/or the nanoparticulate phosphorus-containing flame retardant system comprises from 0.01 to 10% by weight of protective colloids and/or crystallization modifiers.

The invention also provides a process for the production of polymer moldings, polymer films, polymer filaments and polymer fibers, by means of injection molding.

The processing temperatures in the abovementioned process are from 200 to 250° C. for polystyrene, from 200 to 300° C. for polypropylene, from 250 to 290° C. for polyethylene terephthalate (PET), from 230 to 270° C. for polybutylene terephthalate (PBT), from 260 to 290° C. for nylon-6 (PA 6), from 260 to 290° C. for nylon-6,6 (PA 6.6), from 280 to 320° C. for polycarbonate.

M is preferably aluminum, calcium, titanium, zinc, tin, or zirconium. Among protonated nitrogen bases, preference is given to the protonated bases of ammonia, melamine, triethanolamine, in particular NH₄⁺.

Phosphinic salts which may be used with preference are aluminum trisdiethylphosphinate, aluminum trismethylethylphosphinate, aluminum trisdiphenylphosphinate and mixtures of these.

The aluminum trisdiethylphosphinates comprise, if appropriate, from 0.01 to 10% of ancillary constituents from the group of aluminum ethylbutylphosphinate, aluminum ethylphosphonate, aluminum phosphite and/or aluminum hypophosphite.

Other phosphinic salts which may be used with preference are zinc bisdiethylphosphinate, zinc bismethylethylphosphinate, zinc bisdiphenylphosphinate, and mixtures thereof.

The zinc bisdiethylphosphinate here comprises, if appropriate, from 0.01 to 10% of ancillary constituents from the group of zinc ethylbutylphosphinate, zinc ethylphosphonate, zinc phosphite, and/or zinc hypophosphite.

Other phosphinic salts which may be used with preference are titanyl bisdiethylphosphinate, titanium tetrakisdiethylphosphinate, titanyl bismethylethylphosphinate, titanium tetrakismethylethylphosphinate, titanyl bisdiphenylphosphinate, titanium tetrakisdiphenylphosphinate, and any desired mixtures thereof.

The preferred bulk density of the nanoparticulate phosphorus-containing flame retardant system which may be used according to the invention is from 10 to 1000 g/l, in particular from 40 to 400 g/l, and its residual moisture level is from 0.01 to 10% by weight, particularly preferably from 0.1 to 1% by weight.

The preferred L color values of the nanoparticulate phosphorus-containing flame retardant system which may be used according to the invention are from 85 to 99.9, particularly preferably from 90 to 98.

The a color values of the nanoparticulate phosphorus-containing flame retardant system which may be used according to the invention are preferably from −4 to +9, particularly preferably from −2 to +6, and their b color values are preferably from −2 to +6, particularly preferably from −1 to +3.

The color values are stated in the Hunter system (CIE-LAB System, Commission Internationale d'Eclairage). L values range from 0 (black) to 100 (white), a values from −a (green) to +a (red), and b values from −b (blue) to +b (yellow).

Nanoparticulate phosphorus-containing flame retardant systems with L values below the abovementioned ranges or with a or b values outside the abovementioned ranges require higher use of white pigment. This impairs the mechanical stability properties of the polymer molding (e.g. modulus of elasticity).

The nanoparticulate phosphorus-containing flame retardant system is preferably in dispersion in polymers.

The nanoparticulate phosphorus-containing flame retardant system preferably has the final particle size prior to dispersion in polymers. This is achieved via suitable preparation processes, these preferably being carried out in suitable minireactors and/or microreactors, as described in DE-A-101 48 615 and/or EP-A-1 167 461.

The preferred throughput in a microreactor is from 10⁻³ l/h to 10³ l/h, and the preferred throughput in a minireactor is from 10² l/h to 10⁵ l/h.

The method of conducting the reaction is preferably to react a suitable aluminum compound, zinc compound, titanium compound, zirconium compound, and/or tin compound (component A) with a soluble compound of phosphinic acid of the formula (I) and/or diphosphinic acid of the formula (II), and/or their polymers (component B). The ratio A:B in which the components A) and B) are used is preferably from 100:1 to 1:100 metal charge equivalents/mol of phosphorus, particularly preferably from 10:1 to 1:10 metal charge equivalents/mol of phosphorus. Metal charge equivalent here is the fraction obtained by dividing the number of moles of metal by the charge number of the metal species.

Preferred conditions are temperatures of from 0 to 300° C. and reaction times of from 1*10⁻⁷ to 1*10² h. The pressure may be from 0.1 to 196 MPa.

From 0.01 to 10% by weight of protective colloids and/or crystallization modifiers, based on nanoparticulate phosphorus-containing flame retardant system, are preferably used during the reaction of components A and B.

Examples of preferred protective colloids and/or crystallization modifiers are polymeric quaternary ammonium salts (®Genamin PDAC, Clariant), polyethyleneimine (®Lupasol G 20, BASF), gallic acid, gelatin, phosphonic acids and their salts (ethylphosphonic acid, [(phosphonomethyl)imino] bis[2,1-ethanediylnitrilobis(methylene)] tetrakisphosphonic acid (®Cublen D50), aminotris(methylene) phosphonic acid (®Cublen AP 5), 1-hydroxyethane-1,1-diphosphonic acid (®Cublen K 60) and/or sodium pyrophosphate.

Another process for the preparation of a nanoparticulate phosphorus-containing flame retardant system is the sol-gel process, where the abovementioned component A is hydrolyzed and then is reacted with one of the abovementioned components B. In another embodiment, component A is hydrolyzed in the presence of component B.

Component A is preferably an organic aluminum/titanium/zinc/tin/zirconium compound.

Preferred organic aluminum/titanium/zinc/tin/zirconium compounds are aluminum/titanium/zinc/tin/zirconium alkoxides, and in particular aluminum alkoxides are aluminum n-butoxide, aluminum sec-butoxide, aluminum tert-butoxide, and/or aluminum isopropoxide; stannic tert-butoxide; zirconium(IV) tert-butoxide; titanium(IV) n-propoxide (®Tilcom NPT, Vertec NPT), titanium(IV) n-butoxide, titanium chloride triisopropoxide, titanium(IV) ethoxide, titanium(IV) 2-ethylhexoxide (®Tilcom EHT, ®Vertec EHT). Use of acetylacetonate as chelating agent is preferred here.

The abovementioned reaction can in turn be carried out in a microreactor or minireactor under the usual conditions.

The nanoparticulate phosphorus-containing flame retardant system which may be used with preference may be prepared via wet-grinding, where it is dispersed at a concentration of from 0.1 to 50% by weight, preferably from 1 to 20% by weight, in a solvent, and is then wet-ground.

As described above, the invention also provides flame-retardant polymer molding compositions which comprise nanoparticulate phosphorus-containing flame retardant systems. The expression polymer molding compositions here is synonymous with composites or compounded materials.

The volume flow index (melt flow index, MFI, MVR) can also be utilized to assess compatibility. A sharp rise in the MVR value indicates polymer degradation.

Preferred polymers are polymers of mono- and diolefins, for example polypropylene, polyisobutylene, poly-1-butene, poly-4-methyl-1-pentene, polyisoprene, or polybutadiene, and also polymers of cycloolefins, e.g. of cyclopentene or norbornene; also polyethylene (which may, where appropriate, have been crosslinked), e.g. high-density polyethylene (HDPE), high-density high-molecular-weight polyethylene (HMWHDPE), high-density ultra high-molecular-weight polyethylene (UHMWHDPE), medium-density polyethylene (MDPE), low-density polyethylene (LDPE), linear low-density polyethylene (LLDPE), and branched low-density polyethylene (VLDPE) or a mixture thereof.

Other preferred polymers are copolymers of mono- and diolefins with one another or with other vinyl monomers, e.g. ethylene-propylene copolymers, linear low-density polyethylene (LLDPE), and mixtures of the same with low-density polyethylene (LDPE), propylene-1-butene copolymers, propylene-isobutylene copolymers, ethylene-1-butene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and copolymers of these with carbon monoxide, and ethylene-acrylic acid copolymers and salts of these (ionomers), and also terpolymers of ethylene with propylene and with a diene, such as hexadiene, dicyclopentadiene, or ethylidenenorbornene; also mixtures of these copolymers with one another, e.g. polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers, and alternating-structure or random-structure polyalkylene-carbon monoxide copolymers, and mixtures of these with other polymers, e.g. with polyamides. Other preferred polymers are hydrocarbon resins (e.g. C₅-C₉), inclusive of hydrogenated modifications thereof (e.g. tackifier resins), and mixtures of polyalkylenes and starch.

Other preferred polymers are polystyrene, poly(p-methylstyrene), and/or poly(alpha-methylstyrene).

Other preferred polymers are copolymers of styrene or alpha-methylstyrene with dienes or with acrylic derivatives, e.g. styrene-butadiene, styrene-acrylonitrile, styrene-alkyl methacrylate, styrene-butadiene-alkyl acrylate, styrene-butadiene-alkyl methacrylate, styrene-maleic anhydride, styrene-acrylonitrile-methyl acrylate; mixtures with high impact resistance made from styrene copolymers with another polymer, e.g. with a polyacrylate, with a diene polymer, or with an ethylene-propylene-diene terpolymer; and block copolymers of styrene, e.g. styrene-butadiene-styrene, styrene-isoprene-styrene, styrene-ethylene/butylene-styrene, and styrene-ethylene/propylene-styrene.

Other preferred polymers are graft copolymers of styrene or alpha-methylstyrene, e.g. styrene on polybutadiene, styrene on polybutadiene-styrene copolymers, styrene on polybutadiene-acrylonitrile copolymers, styrene and acrylonitrile (and, respectively, methacrylonitrile) on polybutadiene; styrene, acrylonitrile, and methyl methacrylate on polybutadiene; styrene and maleic anhydride on polybutadiene; styrene, acrylonitrile, and maleic anhydride or maleimide on polybutadiene; styrene and maleimide on polybutadiene, styrene and alkyl acrylates and, respectively, alkyl methacrylates on polybutadiene, styrene and acrylonitrile on ethylene-propylene-diene terpolymers, styrene and acrylonitrile on polyalkyl acrylates or on polyalkyl methacrylates, styrene and acrylonitrile on acrylate-butadiene copolymers, and also mixtures of these, e.g. those known as ABS polymers, MBS polymers, ASA polymers, or AES polymers.

Other preferred polymers are halogen-containing polymers, e.g. polychloroprene, chlorinated rubber, chlorinated and brominated isobutylene-isoprene copolymer (halobutyl rubber), chlorinated or chlorosulfonated polyethylene, copolymers of ethylene with chlorinated ethylene, epichlorohydrin homo- and copolymers, and in particular polymers of halogen-containing vinyl compounds, e.g. polyvinyl chloride, polyvinylidene chloride, polyvinyl fluoride, polyvinylidene fluoride; and copolymers of these, such as vinyl chloride-vinylidene chloride, vinyl chloride-vinyl acetate, and vinylidene chloride-vinyl acetate.

Other preferred polymers are polymers derived from alpha, beta-unsaturated acids or some derivatives of these, for example polyacrylates and polymethacrylates, butyl-acrylate-impact-modified polymethyl methacrylates, polyacrylamides, and polyacrylonitriles, and copolymers of the monomers mentioned with one another or with other unsaturated monomers, e.g. acrylonitrile-butadiene copolymers, acrylonitrile-alkyl acrylate copolymers, acrylonitrile-alkoxyalkyl acrylate copolymers, acrylonitrile-vinyl halide copolymers, and acrylonitrile-alkyl methacrylate-butadiene terpolymers.

Other preferred polymers are polymers derived from unsaturated alcohols or amines and, respectively, their acyl derivatives or acetals, for example polyvinyl alcohol, polyvinyl acetate, polyvinyl stearate, polyvinyl benzoate, polyvinyl maleate, polyvinyl butyral, polyallyl phthalate, polyallylmelamine; or copolymers of these with olefins.

Other preferred polymers are homo- and copolymers of cyclic ethers, e.g. polyalkylene glycols, polyethylene oxide, polypropylene oxide, or copolymers of these with bisglycidyl ethers.

Other preferred polymers are polyacetals, such as polyoxymethylene, and polyoxymethylenes which contain comonomers, e.g. ethylene oxide; polyacetals modified with thermoplastic polyurethanes, with acrylates, or with MBS.

Other preferred polymers are polyphenylene oxides or polyphenylene sulfides, or a mixture of these with styrene polymers or with polyamides.

Other preferred polymers are polyurethanes derived, on the one hand, from polyethers, polyesters, or polybutadienes having terminal hydroxy groups, and, on the other hand, from aliphatic or aromatic polyisocyanates, or else precursors of these polyurethanes.

Other preferred polymers are polyamides and copolyamides derived from diamines and dicarboxylic acids, and/or from aminocarboxylic acids, or from the corresponding lactams, for example nylon-4, nylon-6 (®Akulon K122, DSM; ®Zytel 7301, DuPont; ®Durethan B 29, Bayer), nylon-6,6 (®Zytel 101, DuPont; ®Durethan A30, ®Durethan AKV, ®Durethan AM, Bayer; ®Ultramid A3, BASF) -6,10, -6,9, -6,12, -4,6, -12,12, nylon-11, nylon-12 (®Grillamid L20, Ems Chemie), aromatic polyamides based on m-xylene, diamine and adipic acid; polyamides prepared from hexamethylenediamine and iso- and/or terephthalic acid and, where appropriate, an elastomer as modifier, e.g. poly-2,4,4-trimethylhexamethyleneterephthalamide or poly-m-phenyleneisophthalamide. Other suitable polymers are block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol. EPDM- or ABS-modified polyamides or copolyamides are also suitable, as are polyamides condensed during processing (“RIM polyamide systems”).

Other preferred polymers are polyureas, polyimides, polyamideimides, polyetherimides, polyesterimides, polyhydantoins, or polybenzimidazoles.

Other preferred polymers are polyesters derived from dicarboxylic acids and dialcohols and/or from hydroxycarboxylic acids, or from the corresponding lactones, for example polyethylene terephthalate, polybutylene terephthalate (®Celanex 2500, ®Celanex 2002, Celanese; ®Ultradur, BASF), poly-1,4-dimethylolcyclohexane terephthalate, polyhydroxybenzoates, and also block polyetheresters derived from polyethers having hydroxyl end groups; said polyesters modified with polycarbonates or with MBS.

Other preferred polymers are polycarbonates or polyester carbonates, polysulfones, polyether sulfones, or polyether ketones.

Other preferred polymers are crosslinked polymers derived, on the one hand, from aldehydes and, on the other hand, from phenols, urea, or melamine, for example phenol-formaldehyde resins, urea-formaldehyde resins, or melamine-formaldehyde resins.

Other preferred polymers are drying and non-drying alkyd resins.

Other preferred polymers are unsaturated polyester resins derived from copolyesters of saturated or unsaturated dicarboxylic acids with polyhydric alcohols, and also vinyl compounds as crosslinking agents, or else halogen-containing, flame-retardant modifications of these.

Other preferred polymers are crosslinkable acrylic resins derived from substituted acrylic esters, e.g. from epoxyacrylates, from urethane acrylates, or from polyester acrylates.

Other preferred polymers are alkyd resins, polyester resins, or acrylate resins which have been crosslinked by melamine resins, by urea resins, by isocyanates, by isocyanurates, by polyisocyanates, or by epoxy resins.

Other preferred polymers are crosslinked epoxy resins derived from aliphatic, cycloaliphatic, heterocyclic, or aromatic glycidyl compounds, e.g. products of bisphenol A diglycidyl ethers or of bisphenol F diglycidyl ethers, which are crosslinked by way of conventional hardeners, e.g. anhydrides or amines, with or without accelerators.

Other preferred polymers are mixtures (polyblends) of the abovementioned polymers, e.g. PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PU, PC/thermoplastic PU, POM/acrylate, POM/MBS, PPO/HIPS, PPO/PA 6.6 and copolymers, PA/HDPE, PA/PP, PA/PPO, PBT/PC/ABS, and PBT/PET/PC.

Preferred forms of reinforcing materials for flame-retardant polymer molding compositions and flame-retardant polymer moldings are fibers, nonwovens, mats, textiles, strands, tapes, flexible tubes, braids, solid bodies, moldings, and hollow bodies.

Preferred materials for reinforcing materials for flame-retardant polymer molding compositions and flame-retardant polymer moldings are inorganic materials, such as E glass (aluminum boron silicate glass for general plastics reinforcement and for electrical applications), R glass, and S glass (specialty glasses for high mechanical requirements even at an elevated temperature, D glass (specialty glass for increased dielectric requirements even at an elevated temperature), C glass (alkali-lime glass with increased boron addition for particular chemicals resistance), quartz glass, carbon, minerals, metal (steel, aluminum, magnesium, molybdenum, tungsten), ceramics (metal oxides).

Other preferred materials for reinforcing materials for flame-retardant polymer molding compositions and flame-retardant polymer moldings are polycondensates, e.g. nylon-6 (e.g. ®Perlon), nylon-6,6 (e.g. ®Nylon), nylon-11 (e.g. ®Rilsan, ®Qiana), aromatic polyamides (poly-m-phenyleneisophthalamide (e.g. ®Nomex), poly-p-phenyleneterephthalamide (e.g. ®Aramid, ®Kevlar)), polyethylene glycol terephthalate (e.g. ®Dacron, ®Diolen, ®Terylene, ®Trevira, ®Vestan, etc.), poly-1,4-dimethylene cyclohexaneterephthalate (e.g. ®Kodel, ®Vestan X 160, etc.), polycarbonate, polyurethane elastomers (e.g. ®Dorlastan, ®Lycra, etc.).

Other preferred materials for reinforcing materials for flame-retardant polymer molding compositions and flame-retardant polymer moldings are polymers such as polyethylene, polypropylene, polyacrylonitrile homopolymer, polyacrylonitrile copolymer (e.g. ®Dralon, ®Orlon), modacrylics (e.g. ®Kanekalon, ®Venel), atactic polyvinyl chloride (e.g. ®Rhovyl, ®Fibravyl), syndiotactic polyvinyl chloride (e.g. ®Leavil), polyvinyl alcohol (e.g. ®Kuralon, ®Vinylal, ®Vinylon), polytetrafluoroethylene (e.g. ®Teflon, ®Hostaflon), polystyrene (e.g. ®Polyfiber, ®Styroflex).

Other preferred materials for reinforcing materials for flame-retardant polymer molding compositions and flame-retardant polymer moldings are naturally occurring and semisynthetic fibers (viscose cellulose, copper cellulose, cellulose acetate, cellulose triacetate, flax, hemp, sisal, jute, ramie, cotton).

Preferred dimensions for short glass fibers are lengths of from 0.01 to 10 mm and diameters of from 0.005 to 0.015 mm.

The flame-retardant polymer molding composition is preferably in pellet form (compounded material). The pellets preferably have cylindrical shape with a circular, elliptical, or irregular base, or the shape of a sphere, cushion, cube, parallelepiped, or prism.

The length:diameter ratio of the pellets is from 1:50 to 50:1, preferably from 1:5 to 5:1, and the diameter of the pellets is preferably from 0.5 to 15 mm, particularly preferably from 2 to 3 mm, and their length is preferably from 0.5 to 15 mm, particularly preferably from 2 to 5 mm.

Preferred process for the preparation of flame-retardant polymer molding compositions is the polymerization of the inventive polymer in the presence of the nanoparticulate phosphorus-containing flame retardant system (in-situ polymerization).

Preferred thermoplastic polymers are polyamides, polyimides, polystyrenes, polyesters, polyolefins, and polymers of alpha-beta-unsaturated monomers, and copolymers.

In the case of the free-radical polymerization process, monomer, nanoparticulate phosphorus-containing flame retardant system, and initiator are mixed by a high-speed mixer and polymerized. Preferred conditions are temperatures of from 0 to 300° C., preferably from 50 to 150° C. and times of from 0.01 to 100 h. The pressure can vary from 1 to 200 MPa.

In the case of hydrophobic monomers, suspension polymerization is particularly preferred. Addition of emulsifying agents and of inventive solvents is then preferred.

Particular preference is given to styrene, alkylstyrenes, and divinylbenzene. Particular preference is given to styrene, alpha-methylstyrene, p-methylstyrene, and divinylbenzene. According to the invention, one or more types of the abovementioned styrenes may be (co)polymerized in any desired configuration.

Suitable emulsifying agents are anionic surfactants, e.g. sodium rosinate, sodium stearate, potassium oleate, sodium laurate, and sodium dodecylbezenesulfonate; cationic surfactants, e.g. cetyltrimethylammonium bromide and dodecylamine chloride; nonionic surfactants, e.g. nonyl polyoxyethylene ethers and octylphenyl polyoxyethylene ethers, etc. These emulsifying agents may be used alone or in a mixture with one another.

Suitable solvents are water, alcohols, such as methanol, ethanol, isopropanol, n-propanol, n-butanol, isobutanol, tert-butanol, n-amyl alcohol, isoamyl alcohol, tert-amyl alcohol, n-hexanol, n-octanol, isooctanol, n-tridecanol, benzyl alcohol, etc. Preference is also given to glycols, e.g. ethylene glycol, 1,2-propanediol, 1,3-propanediol, 1,3-butanediol, 1,4-butanediol, diethylene glycol, etc.; aliphatic hydrocarbons, such as pentane, hexane, heptane, octane, and petroleum ether, naphtha, kerosene, petroleum, paraffin oil, etc.; aromatic hydrocarbons, such as benzene, toluene, xylene, mesitylene, ethylbenzene, diethylbenzene, etc.; halogenated hydrocarbons, such as methylene chloride, chloroform, 1,2-dichloroethane, chlorobenzene, carbon tetrachloride, tetrabromoethylene, etc.; alicyclic hydrocarbons, such as cyclopentane, cyclohexane, and methylcyclohexane, etc.; ethers, such as anisole (methyl phenyl ether), tert-butyl methyl ether, dibenzyl ether, diethyl ether, dioxane, diphenyl ether, methyl vinyl ether, tetrahydrofuran, diisopropyl ether, etc.; glycol ethers, such as diethylene glycol diethyl ether, diethylene glycol dimethyl ether (diglyme), diethylene glycol monobutyl ether, diethylene glycol monomethyl ether, 1,2-dimethoxyethane (DME, monoglyme), ethylene glycol monobutyl ether, triethylene glycol dimethyl ether (triglyme), triethylene glycol monomethyl ether, etc.; ketones, such as acetone, diisobutyl ketone, methyl n-propyl ketone; methyl ethyl ketone, methyl isobutyl ketone, etc.; esters, such as methyl formate, methyl acetate, ethyl acetate, n-propyl acetate, and n-butyl acetate, etc.; carboxylic acids, such as formic acid, acetic acid, propionic acid, butyric acid, etc. One or more of these compounds may be used alone or in combination.

Suitable initiators are any of the systems which generate free radicals. Peroxo compounds and/or azo initiators are particularly preferred.

In the case of the polycondensation process, monomers and monomer mixtures are used as initial charge and a phosphorus-containing flame retardant system is mixed by a high-speed mixer, and the material is polymerized.

Suitable polyesters give rise from the condensation of aromatic, cycloaliphatic, and aliphatic diols with aliphatic, aromatic and cycloaliphatic dicarboxylic acids, and may be cycloaliphatic, aliphatic, or aromatic polyesters.

Examples are polyethylene terephthalates, polycyclohexylenedimethylene terephthalates, polyethylene dodecates, polybutylene terephthalates, polyethylene naphthalate, polyethylene 2,7-napththalate, poly-meta-phenylene isophthalate, polyglycolic acid, polyethylene succinate, polyethylene adipates, polyethylene sebacate, polydecamethylene azelate, polydecamethylene adipate, polydecamethylene sebacate, polydimethylpropiolactone, poly-para-hydroxybenzoate (Ekonol), polyethyleneoxy benzoates (A-tell), polyethylene isophthalate, polytetramethylene terephthalate, polyhexamethylene terephthalate, polydecamethylene terephthalate, poly-1,4-cyclohexanedimethylene terephthalate (trans), polyethylene 1,5-naphthalate, polyethylene 2,6-naphthalate, poly-1,4-cyclo-hexylenedimethylene terephthalate (Kodel) (cis/trans).

Suitable polyamides are linear polycarboxamides in which there are at least two carbon atoms separating the carboxamide repeat groups from one another. Examples are the copolyamide composed of 30% of hexamethylenediammonium isophthalate and 70% of hexamethylenediammonium adipate, polyhexamethyleneadipamides (nylon-6,6), polyhexamethylene sebacamide (nylon-6,10), polyhexamethyleneisophthalamide, polyhexamethyleneterephthalamide, polyheptamethylenepimelamides (nylon-7,7), polyoctamethylenesuberamide (nylon-8,8), polynonamethyleneazelamides (nylon-9,9), poly(decamethyleneazelamide) (nylon-10,9), polydecamethylenesebacamide (nylon-10,10), polybis-4-aminocyclohexylmethane-1,10-decanecarboxamide, poly-m-xyleneadipamide, poly-p-xylenesebacamide, poly-2,2,2-trimethylhexamethyleneterephthalamide, polypiperazinesebacamide, poly-p-phenyleneterephthalamide, poly-meta-phenyleneisophthalamide, etc. Other examples are poly-4-aminobutyric acid (nylon-4), poly-6-aminohexanoic acid (nylon-6), poly-7-aminoheptanoic acid (nylon-7), poly-8-aminooctanoic acid (nylon-8), poly-9-aminononanoic acid (nylon-9), poly-10-aminodecanoic acid (nylon-10), poly-11-aminoundecanoic acid (nylon-11), poly-12-aminododecanoic acid (nylon-12), etc.

The melt dispersion process converts a non-nanoparticulate phosphorus-containing flame retardant system to a nanoparticulate phosphorus-containing flame retardant system and simultaneously disperses it in the polymer.

The term melt dispersion is synonymous with extrusion, compounding, and/or preparation of a masterbatch.

An example of a method for incorporating the phosphorus-containing flame retardant system into thermoplastic polymers premixes all of the constituents in the form of powder and/or pellets in a mixer and then homogenizes them in a compounding assembly (e.g. a twin-screw extruder) in the polymer melt. The components may also be introduced separately by means of a feed system, directly into the compounding assembly.

During the melt dispersion process, the dispersion of the nanoparticulate phosphorus-containing flame retardant system in the matrix polymer is influenced via the addition of compatibilizers, the mixing time, the shear load, and the polymer viscosity.

In the case of polyolefin matrix polymers, preference is given to compatibilizers, such as anhydride-modified oligomers or hydroxy-containing polyolefin oligomers. Among these, particular preference is given to polypropylene-maleic anhydride copolymer, e.g. ®Polybond 3000 (with 1.2% of maleic-acid-modified polypropylene, Crompton, Middlebury, USA), ®Polybond 3200 and 2000, and ®Orevac-CA100 (Elf Atochem Co. Ltd., Maleic-anhydride-polypropylene copolymer, Mw=30 000-50 000).

Other examples of compatibilizers are organosilanes of the structure: RₙSiX(₄₋ₙ) where n is an even number from 1 to 3 and R is an organic radical which contains a carbon atom directly bonded to the silicon atom, and where X is an alkoxy, acryloxy, amino or halogen radical. The organic radical contains from 1 to 20 carbon atoms and can be alkyl, aryl, alkaryl, arylalkyl, vinyl, allyl, aminoalkyl, aminoaryl, and other organic radicals which contain ether, ketone, ester, epoxy, amine and/or carboxy groups.

Preferred silanes are (3-glycidoxypropyl)trimethoxysilane, 3-aminopropylmethyldiethoxysilane, vinyltriethoxysilane, phenyltriethoxysilane, 3-mercapto-propylmethyldimethoxysilane, 3-glycidoxypropyltrimethoxysilane, bis(2-hydroxyethyl)aminopropyltriethoxysilane, (3-glycidoxypropyl)methyldiethoxysilane, aminopropyltriethoxysilane and allyltrimethoxysilane, etc.

Other examples of compatibilizers are quaternary ammonium compounds which have at least one alkyl substituent on the nitrogen atom having from 12 to 22 carbon atoms. The other nitrogen substituents may (a) be linear or branched alkyl groups containing from 1 to 22 carbon atoms, (b) be arylalkyl groups, e.g. benzyl and substituted benzyl groups, and (c) be aryl groups, e.g. phenyl and substituted phenyl groups. The quaternary ammonium compounds may be represented by the following formula: R¹R²R³R⁴N⁺X⁻, where M is an anion, e.g. chloride, bromide, iodide, nitrite, nitrates, sulfates, hydroxides, C₁C₁₈-carboxylate, etc.; where R¹ is an alkyl group containing from 12 to 22 carbon atoms, and R², R³, and R⁴ are an alkyl group containing from 12 to 22 carbon atoms, arylalkyl groups containing from 7 to 22 carbon atoms, aryl groups containing from 6 to 22 carbon atoms, and mixtures of these.

Preferred quaternary ammonium compounds are those where R¹ and R² are alkyl groups having from 12 to 22 carbon atoms, and R³ and R⁴ are methyl, and those in which R¹ are alkyl groups having from 12 to 22 carbon atoms, R² is benzyl, and R³ and R⁴ are methyl, or a mixture of these.

The long-chain alkyl groups can derive from naturally occurring vegetable and/or animal fats or oils, or from petroleum chemicals, e.g. maize oil, cottonseed oil, coconut oil, soy oil, castor oil, and/or tallow oil.

Other alkyl groups which may be present in the quaternary ammonium compounds are methyl, ethyl, propyl, butyl, hexyl, 2-ethylhexyl, decyl, dodecyl, lauryl, stearyl, and the like.

Aryl groups include phenyl and substituted phenyl groups. Arylalkyl groups include benzyl groups and substituted benzyl groups.

Inventive quaternary ammonium compounds are dimethyldi(hydrogenated tallow fat)ammonium chloride, methyltri(hydrogenated tallow fat)ammonium chloride, dimethylbenzyl(hydrogenated tallow fat)ammonium chloride, methylbenzyldi(hydrogenated tallow fat)ammonium chloride, octadecyldimethyl(3-trimethoxysilylpropyl)ammonium salt, dodecylammonium salt, octadecyltrimethylammonium salt, bis(2-hydroxyethyl(octadecylmethylammonium salt, octadecylbenzyldimethylammonium salt, hexadecyltrimethylammonium salt, etc.

Preferred compounding machines are various sizes and designs of twin-screw kneaders. Preference is given to the ZSK Mega Compounder, ZSK Mega Volume (Krupp Werner & Pfleiderer), Berstorff ZE 25, Leistritz ZSE-27, etc.

Further preference is given to MDK 46 co-kneaders (e.g. with L/D=11 from Buss, Switzerland), i.e. single-screw kneaders with hinged barrel.

Preference is given to temperatures at the melting point of the plastic to be processed. The melt is usually drawn off in the form of a strand, cooled, and pelletized.

The inventive flame retardant composition is preferably used in flame-retardant polymer molding compositions which are subsequently used to produce flame-retardant polymer moldings. The polymer of the polymer moldings, polymer films, polymer filaments or polymer fibers is preferably a thermoplastic or thermoset polymer.

Surprisingly, it has been found that the mechanical properties of flame-retardant polymer moldings based on the inventive compression-granulated flame retardant compositions or flame-retardant molding compositions are considerably better than those of the prior art.

Test methods

a) Determination of Median Particle Size

An Ultra-Turrax mixer is used to disperse 1 g of the solid specimen in a solution of 3% of isopropanol in water. Using a Malvern 4700 C instrument, photocorrelation spectroscopy is used to determine the median particle size.

b) Determination of the Particle Size of the Nanoparticulate Flame Retardant System in the Polymer Molding Compositions and Polymer Molding Matrix

The specimen of the composite is measured in a Philips PW1710 X-ray powder diffractometer (CuK_{alpha 2} radiation, wavelength 1.54439 Angström, acceleration voltage 35 kV, heating current 28 mA, Monochromator, scan rate 3 degrees 2 theta per minute). The median primary particle size D is calculated by the Scherrer method from the line width (beta) of the X-ray reflection at the diffraction angle theta at the position of half-maximum intensity: D=1.54439 [ang]*57.3/(beta*cosine (theta)) (see H. Krischner, Einführung in die Röntgenfeinstrukturanalyse [Introduction to X-ray fine-structure analysis], Vieweg (1987) 106-110).

Preparation, Processing and Testing of Flame-Retardant Polymer Molding Compositions and of Flame-Retardant Polymer Moldings.

The flame retardant system components are mixed with the polymer pellets and optionally with additives, and incorporated in a twin-screw extruder (ZSK 25 WLE, 14.5 kg/h, 200 rpm, L/D: 4) at temperatures of 170° C. (polystyrene), from 230 to 260° C. (PBT), or of 260° C. (PA6), or from 260 to 280° C. (PA 66). The homogenized polymer strand is drawn off, cooled in a water bath, and then pelletized.

After adequate drying, the molding compositions were processed to give test specimens in an injection-molding machine (Aarburg Allrounder) at melt temperatures of from 240 to 270° C. (PBT), or of 275° C. (PA 6), or of from 260 to 290° C. (PA 66).

Determination of mechanical properties on flame-retardant polymer moldings: Tensile strain at break was determined by a method based on DIN EN ISO 527-1.

Impact resistance was determined by a method based on ISO 180.

Determination of Flame Retardancy Properties on Flame-Retardant Polymer Moldings:

The test specimens are tested and classified for flame retardancy on the basis of the UL 94 test (Underwriters Laboratories).

The UL 94 (Underwriters Laboratories) fire classification was determined on test specimens from each mixture, using test specimens of thickness 1.5 mm. The UL 94 fire classifications are as follows:

V-0: afterflame time never longer than 10 sec., total of afterflame times for 10 flame applications not more than 50 sec., no flaming drops, no complete consumption of the specimen, afterglow time for specimens never longer than 30 sec. after end of flame application.

V-1: afterflame time never longer than 30 sec. after end of flame application, total of afterflame times for 10 flame applications not more than 250 sec., afterglow time for specimens never longer than 60 sec. after end of flame application, other criteria as for V-0.

V-2: cotton indicator ignited by flaming drops; other criteria as for V-1.

Not classifiable (ncl): does not comply with fire classification V-2.

IEC 60695-1-13 was used for glow-wire ignition test determinations.

Determination of SV Number (Specific Viscosity)

0.5 g of the polymer specimen (e.g. PBT) is weighed into a 250 ml Erlenmeyer flask with ground glass stopper, with 50 ml of dichloroacetic acid (solvent). The specimen is dissolved over a period of 16 h, with stirring at 25° C. The solution is filtered through a G1 glass frit. 20 ml of the solution are charged to the capillary, suspended in the (Ubbelohde) capillary viscometer, and controlled to a temperature of 25° C. The SV value is calculated from the following formula: SV value=100*[flow time (specimen solution)/flow time (solvent)-1].

Instead of dichloroacetic acid, a mixture of phenol and 1,2-dichlorobenzene (1:1, w/w) or m-cresol can also be used for polyethylene terephthalate and polybutylene terephthalate. Sulfuric acid, formic acid, or m-cresol can be used for polyamide.

### EXAMPLES

### Example 1

99.9 parts by weight of aluminum diethylphosphinate 2 are mixed with 0.1 part by weight of alkylsiloxane (in the form of a 10% strength solution in ethanol) in a Lödige mixer, and the product is then dried in a drying cabinet at 120° C. for 2 h.

### Example 2

99 parts by weight of aluminum diethylphosphinate 2 are mixed with 1 part by weight of alkylsiloxane (in the form of a 10% strength solution in ethanol) in a Lödige mixer, and the product is then dried in a drying cabinet at 120° C. for 2 h.

### Example 3

90 parts by weight of aluminum diethylphosphinate 2 are mixed with 10 parts by weight of alkylsiloxane (in the form of a 10% strength solution in ethanol) in a Lödige mixer, and the product is then dried in a drying cabinet at 120° C. for 2 h.

### Example 4

A solution of 72 g of sodium diethylphosphinate in 410.6 g of water is heated to 80° C. and then treated with 107 g of aluminum sulfate solution (4.2% by weight of Al) in a microreactor over a period of 3 h. The product is washed free from electrolyte via centrifuging and dried at 120° C. for 5 h.

### Example 5

A solution of 72 g of sodium diethylphosphinate and 0.65 g of polyethyleneimine in 410.6 g of water is heated to 80° C. and then treated with 107 g of aluminum sulfate solution (4.2% by weight of Al) in a microreactor over a period of 3 h. The product is washed free from electrolyte via centrifuging and dried at 120° C. for 5 h.

### Example 6

4.54 kg of commercially available aluminum diethylphosphinate 1 (median particle diameter about 22 μm) are ground with 90.72 kg of water in a Sweco M-45 mill for 50 h and then dried. The BET surface area is about 66 m²/g, and the median particle size is 0.023 μm.

### Example 7

In accordance with the general specification for “Preparation, processing, and testing of flame-retardant polymer molding compositions and flame-retardant polymer moldings”, 10 parts by weight of aluminum diethylphosphinate 2, 30 parts by weight of glass fibers, and 59.9 parts by weight of nylon-6,6 are processed to give a molding composition. 0.1 part by weight of aminosilane is incorporated as compatibilizer.

### Example 8

By analogy with example 7, 10 parts by weight of aluminum diethylphosphinate 2, 30 parts by weight of glass fibers, and 59 parts by weight of nylon-6,6 are processed to give a molding composition. 1 part by weight of glycidoxysilane is incorporated as compatibilizer.

### Example 9

### Comparison

By analogy with example 7, a molding composition composed of 10% by weight of aluminum diethylphosphinate 1, 5% by weight of melamine polyphosphate, 5% by weight of nanoclay, 30% by weight of glass fibers, and 50% by weight of nylon-6,6 is prepared and processed to give flame-retardant polymer moldings. The test specimens tested to Underwriters Laboratories UL 94 comply with category V-0.

### Example 10

By analogy with example 7, a molding composition composed of 10% by weight of product from example 2, 30% by weight of glass fibers, and 60% by weight of nylon-6,6 is prepared and processed to give flame-retardant polymer moldings. The test specimens tested to Underwriters Laboratories UL 94 comply with category V-0.

### Example 11

By analogy with example 7, a molding composition composed of 10% by weight of product from example 3, 30% by weight of glass fibers, and 60% by weight of nylon-6,6 is prepared and processed to give flame-retardant polymer moldings. The test specimens tested to Underwriters Laboratories UL 94 comply with category V-0.

### Example 12

By analogy with example 7, a molding composition composed of 10% by weight of product from example 4, 30% by weight of glass fibers, and 60% by weight of nylon-6,6 is prepared and processed to give flame-retardant polymer moldings. The test specimens tested to Underwriters Laboratories UL 94 comply with category V-0.

### Example 13

By analogy with example 7, a molding composition composed of 10% by weight of product from example 5, 30% by weight of glass fibers, and 60% by weight of nylon-6,6 is prepared and processed to give flame-retardant polymer moldings. The test specimens tested to Underwriters Laboratories UL 94 comply with category V-0.

### Example 14

By analogy with example 7, a molding composition composed of 7.5% by weight of product from example 2, 2.5% by weight of melamine polyphosphate, 30% by weight of glass fibers, and 60% by weight of nylon-6,6 is prepared and processed to give flame-retardant polymer moldings. The test specimens tested to Underwriters Laboratories UL 94 comply with category V-0.

### Example 15

By analogy with example 7, a molding composition composed of 7.5% by weight of product from example 4, 2.5% by weight of melamine polyphosphate, 30% by weight of glass fibers, and 60% by weight of nylon-6,6 is prepared and processed to give flame-retardant polymer moldings. The test specimens tested to Underwriters Laboratories UL 94 comply with category V-0.

### Example 16

By analogy with example 7, a molding composition composed of 7.5% by weight of product from example 5, 2.5% by weight of melamine polyphosphate, 30% by weight of glass fibers, and 60% by weight of nylon-6,6 is prepared and processed to give flame-retardant polymer moldings. The test specimens tested to Underwriters Laboratories UL 94 comply with category V-0.

### Example 17

By analogy with example 7, a molding composition composed of 7.5% by weight of product from example 6 (5a), 2.5% by weight of melamine polyphosphate, 30% by weight of glass fibers, and 60% by weight of nylon-6,6 is prepared and processed to give flame-retardant polymer moldings. The test specimens tested to Underwriters Laboratories UL 94 comply with category V-0.

### Example 18

By analogy with example 7, a molding composition composed of product from example 7 is prepared and processed to give flame-retardant polymer moldings. The test specimens tested to Underwriters Laboratories UL 94 comply with category V-0.

### Example 19

By analogy with example 7, a molding composition composed of product from example 8 (5c) is prepared and processed to give flame-retardant polymer moldings. The test specimens tested to Underwriters Laboratories UL 94 comply with category V-0.

### Example 20

A solution of 72 g of sodium diethylphosphinate and 0.65 g of Lupasol G20 in 410.6 g of water is heated to 80° C. and then treated with 107 g of aluminum sulfate solution (4.2% by weight of Al) over a period of 3 h. 1.0 g of linear sodium dodecyl-benzenesulfonate is then added. The reaction solution is heated to about 95° C. over a period of 5 h, during which a mixture of 0.2 g of pinene hydroperoxide (44% of active ingredient) and 51.9 g (0.5 mol) of styrene are metered in by a pump. The product is washed free from electrolyte via centrifuging and dried at 120° C. for 5 h.

### Example 21

A solution of 72 g of sodium diethylphosphinate and 0.65 g of gelatin in 410.6 g of water is heated to 80° C. and then treated with 107 g of aluminum sulfate solution (4.2% by weight of Al) over a period of 3 h. 1.0 g of linear sodium dodecyl-benzenesulfonate is then added. The reaction solution is heated to about 95° C. over a period of 5 h, during which a mixture of 0.2 g of pinene hydroperoxide (44% of active ingredient) and 51.9 g (0.5 mol) of styrene are metered in by a pump. The product is washed free from electrolyte via centrifuging and dried at 120° C. for 5 h.

### Example 22

275 g of deionized water are heated to 80° C. and then treated with 41 g of aluminum tri-sec-butoxide over a period of 30 min. This gives a precipitate which can be dissolved over a period of 1 hour by a solution composed of 1.16 g of concentrated nitric acid and 80 g of deionized water. After stirring for three days, the sol is treated with 61 g of diethylenephosphinic acid. 1.0 g of linear sodium dodecyl-benzenesulfonate is then added. The reaction solution is heated to about 95° C. over a period of 5 h, during which a mixture of 0.2 g of pinene hydroperoxide (44% of active ingredient) and 51.9 g (0.5 mol) of styrene are metered in by a pump. The product is washed free from electrolyte via centrifuging and dried at 120° C. for 5 h.

### Example 23

A Brabender laboratory kneader is used to prepare a flame-retardant polymer molding composition composed of polystyrene and product from Example 20 (13), and the composition is processed to give flame-retardant polymer moldings. The test specimens tested to Underwriters Laboratories UL 94 comply with category V-0.

### Example 24

A Brabender laboratory kneader is used to prepare a flame-retardant polymer molding composition composed of polystyrene and product from Example 21, and the composition is processed to give flame-retardant polymer moldings. The test specimens tested to Underwriters Laboratories UL 94 comply with category V-0.

### Example 25

A Brabender laboratory kneader is used to prepare a flame-retardant polymer molding composition composed of polystyrene and product from Example 22 (15), and the composition is processed to give flame-retardant polymer moldings. The test specimens tested to Underwriters Laboratories UL 94 comply with category V-0.

### Example 26

A mixture of 40.8 parts by weight of diurethane dimethacrylate derived from 2,2,4-trimethylhexamethylene diisocyanate and 2-hydroxyethyl methacrylate, 24.5 parts by weight of diurethane diacrylate derived from bis-(diisocyanatomethyl)tricyclodecane and 2-hydroxyethyl acrylate, 4 parts by weight of dodecanediol dimethacrylate, 12.3 parts by weight of tetraacryloyloxyethoxypentaerythritol, 17.9 parts by weight of product from Example 6 (23 18), and 0.18 part by weight of 3-methacryloylpropyltrimethoxysilane are homogenized using a triple-roll mill.

The transparency of the paste is measured in a photometer (quartz cell d=1 mm, type: ELKO 2, Carl Zeiss, filter No. S51 E67). Demineralized water serves as reference solution, and the transparency value measured is read off directly on the equipment. The transparency is 70%.

### Example 27

### Comparison

A mixture of 40.8 parts by weight of diurethane dimethacrylate derived from 2,2,4-trimethylhexamethylene diisocyanate and 2-hydroxyethyl methacrylate, 24.5 parts by weight of diurethane diacrylate derived from bis(diisocyanatomethyl)tricyclodecane and 2-hydroxyethyl acrylate, 4 parts by weight of dodecanediol dimethacrylate, 12.3 parts by weight of tetraacryloyloxyethoxypentaerythritol, 17.9 parts by weight of commercially available aluminum diethylphosphinate 1 (median particle diameter about 22 μm), and 0.18 part by weight of 3-methacryloylpropyltrimethoxysilane are homogenized using a triple-roll mill. Measurement of transparency gives a value of 40%.

### Example 28

part by weight of phenanthrene quinone, 0.2 part by weight of N,N-dimethyl-p-toluidine, 0.02 parts by weight of 2,6-di-tert-butyl-4-methylbenzene are mixed with the product from Example 26. The composition is cured for 360 s in open hollow molds composed of metal, using a photopolymerizer (Dentacolor XS from Heraeus Kulzer GmbH) to give a test specimen. The particle size of the nanoparticulate phosphorus-containing flame retardant system in the flame-retardant polymer molding is 0.1 μm, determined in accordance with the general specification. The test specimens tested to Underwriters Laboratories UL 94 comply with category V-0.

TABLE 1

| Example | | 1 | 2 | 3 |
|---|---|---|---|---|
| Aluminum diethylphosphinate 1 | parts by weight | 99.9 | 99 | 90 |
| Alkylsiloxane | parts by weight | 0.1 | 1 | 10 |

TABLE 2

| Example | | 9 | 10 | 11 | 12 | 13 | 14 | 15 | 16 | 17 | 18 | 19 |
|---|---|---|---|---|---|---|---|---|---|---|---|---|
| Aluminum | % by wt. | 10 | — | — | — | — | — | — | — | — | — | — |
| diethylphosphinate 1 | | | | | | | | | | | | |
| Melamine | % by wt. | 5 | — | — | — | — | 2.5 | 2.5 | 2.5 | 2.5 | — | — |
| polyphosphate | | | | | | | | | | | | |
| Nanoclay | % by wt. | 5 | — | — | — | — | — | — | — | — | — | — |
| Product from | % by wt. | — | 10 | — | — | — | 7.5 | — | — | — | — | — |
| Example 2 | | | | | | | | | | | | |
| Product from | % by wt. | — | — | 10 | — | — | — | — | — | — | — | — |
| Example 3 | | | | | | | | | | | | |
| Product from | % by wt. | — | — | — | 10 | — | — | 7.5 | — | — | — | — |
| Example 4 | | | | | | | | | | | | |
| Product from | % by wt. | — | — | — | — | 10 | — | — | 7.5 | — | — | — |
| Example 5 | | | | | | | | | | | | |
| Product from | % by wt. | — | — | — | — | — | — | — | — | 7.5 | — | — |
| Example 6 | | | | | | | | | | | | |
| Product from | % by wt. | — | — | — | — | — | — | — | — | — | x | — |
| Example 7 | | | | | | | | | | | | |
| Product from | % by wt. | — | — | — | — | — | — | — | — | — | — | x |
| Example 8 | | | | | | | | | | | | |
| Glass fibers | % by wt. | 30 | 30 | 30 | 30 | 30 | 30 | 30 | 30 | 30 | 30 | 30 |
| Nylon-6,6 | % by wt. | 50 | 60 | 60 | 60 | 60 | 60 | 60 | 60 | 60 | 70 | 70 |
| Median particle | μm | 40.00 | 0.50 | 0.10 | 0.20 | 0.20 | 0.25 | 0.15 | 0.20 | 0.05 | 0.40 | 0.30 |
| diameter d50 | | | | | | | | | | | | |
| GWIT to IEC 60695-1-13 | ° C. | 800 | 800 | 800 | 825 | 850 | 800 | 850 | 850 | 850 | 825 | 825 |
| Tensile strain at | % | 1.6 | 1.9 | 2.1 | 2 | 2.2 | 2.2 | 2 | 2.2 | 2 | 1.9 | 2.2 |
| break to DIN 53455 | | | | | | | | | | | | |
| Charpy impact | kJ/m2 | 40 | 55 | 60 | 62 | 55 | 55 | 57 | 60 | 57 | 55 | 62 |
| resistance to ISO | | | | | | | | | | | | |
| 180 | | | | | | | | | | | | |

TABLE 3

| Example | | 23 | 24 | 25 |
|---|---|---|---|---|
| Product from Example 20 | % by wt. | 54.0 | — | — |
| Product from Example 21 | % by wt. | — | 54.0 | — |
| Product from Example 22 | % by wt. | — | — | 54.0 |
| Polystyrene | % by wt. | 46.0 | 46.0 | 46.0 |
| Median particle diameter | μm | 0.25 | 0.15 | 0.15 |
| d50 | | | | |
| P content | % by wt. | 7.2 | 7.2 | 7.2 |

TABLE 4

| | |
|---|---|
| Aluminum | Exolit OP 1230, Clariant Corporation |
| diethylphosphinate 1 | |
| Aluminum | Exolit O 930 (TP), Clariant Corporation |
| diethylphosphinate 2 | |
| Alkylsiloxane | Dynasylan BSM 166, Degussa |
| Aminosilane | gamma-aminopropyltriethoxysilane, Silquest |
| | A-1100 silane, Crompton |
| Glycidoxysilane | 3-Glycidoxypropyltimethoxsilane, Z 6040 |
| | silane, Dow Corning |
| Nanoclay | Nanofill 919, Südchemie |
| Nylon-6,6 | Ultramid A3, BASF |
| Glass fibers | PPG 3540, PPG Industries, Inc. |
| Polystyrene | Polystyrene 143 E, BASF |
| Melamine | Melapur 200/70, Ciba SC |
| polyphosphate | |
| Polyethyleneimine | Lupasol G20, BASF |

1. A flame-retardant polymer molding composition comprising a polymer or a mixture of polymers and a nanoparticulate phosphorus-containing flame retardant system comprising at least one phosphinic salt of the formula (I) a diphosphinic salt of the formula (II), a polymer of the phosphinic salt, a polymer of the diphosphinic salt or a mixture thereof, 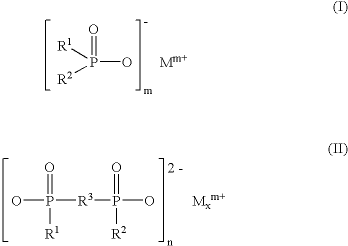
wherein
R¹ and R² are identical or different and are C₁-C₆-alkyl, linear or branched, or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Fe, Zr, Zn, Ce, Bi, Sr, Mn, Li, Na, K, or a protonated nitrogen base;
m is from 1 to 4;
n is from 1 to 4;
x is from 1 to 4.

2. The flame-retardant polymer molding composition as claimed in claim 1, wherein R¹ and R² are identical or different and are C₁-C₆-alkyl, linear or branched, or phenyl.

3. The flame-retardant polymer molding composition as claimed in claim 1, wherein R¹ and R² are identical or different and are methyl, ethyl, n-propyl, isopropyl, n-butyl, tert-butyl, n-pentyl or phenyl.

4. The flame-retardant polymer molding composition as claimed in claim 1, wherein R³ is methylene, ethylene, n-propylene, isopropylene, n-butylene, tert-butylene, n-pentylene, n-octylene, n-dodecylene; phenylene, naphthylene; methylphenylene, ethylphenylene, tert-butylphenylene, methylnaphthylene, ethylnaphthylene, tert-butylnaphthylene; phenylmethylene, phenylethylene, phenylpropylene, or phenylbutylene.

5. The flame-retardant polymer molding composition as claimed in claim 1, wherein the particle size of the nanoparticulate phosphorus-containing flame retardant system is from 1 to 1000 nm.

6. The flame-retardant polymer molding composition as claimed in claim 1, wherein the BET surface area of the nanoparticulate phosphorus-containing flame retardant system is from 2 to 1000 m²/g.

7. The flame-retardant polymer molding composition as claimed in claim 1, wherein the nanoparticulate phosphorus-containing flame retardant system comprises from 0.01 to 10% by weight of at least one of a protective colloid or crystallization modifier.

8. The flame-retardant polymer molding composition as claimed in claim 1, further comprising:
from 0.5 to 45% by weight of the nanoparticulate phosphorus-containing flame retardant system,
from 0.5 to 95% by weight of the polymer or the mixture of polymers, where the entirety of the components is 100% by weight.

9. The flame-retardant polymer molding composition as claimed in claim 1, further comprising:
from 0.5 to 45% by weight of the nanoparticulate phosphorus-containing flame retardant system,
from 0.5 to 95% by weight of the polymer or the mixture of polymers,
from 0.5 to 55% by weight of at least one additive,
from 0.5 to 55% by weight of a filler or a reinforcing material,
where the entirety of the components is 100% by weight.

10. The flame-retardant polymer molding composition as claimed in claim 1, further comprising
from 10 to 40% by weight of the nanoparticulate phosphorus-containing flame retardant system,
from 10 to 80% by weight of the polymer or the mixture of polymers,
from 2 to 40% by weight of at least one additive,
from 2 to 40% by weight of a filler or reinforcing material,
where the entirety of the components is 100% by weight.

11. The flame-retardant polymer molding composition as claimed in claim 1, wherein the polymer or mixture of polymers is a thermoplastic or thermoset polymer.

12. The flame-retardant polymer molding composition as claimed in claim 11, wherein the thermoplastic polymer is selected from the group consisting of high impact polystyrene, polyphenylene ethers, polyamides, polyesters, polycarbonates, polyolefins, polyethers, and blends or polyblends of the type represented by ABS (acrylonitrile-butadiene-styrene) or PC/ABS (polycarbonate/acrylonitrile-butadiene-styrene), polyamide, polyester, polyarylates, polymethacrylates, or ABS.

13. The flame-retardant polymer molding composition as claimed in claim 11, wherein the thermoset polymer is selected from the group consisting of formaldehyde, epoxy, melamine, or phenolic resin polymers, and polyurethanes.

14. The flame-retardant polymer molding compositions as claimed in claim 9, wherein the at least one additive is a nitrogen compound, phosphorus compound, or phosphorus-nitrogen compound.

15. The flame-retardant polymer molding composition as claimed in claim 9, wherein the at least one additive is a nitrogen compound of the formulae (III) to (VIII), or a mixture thereof, 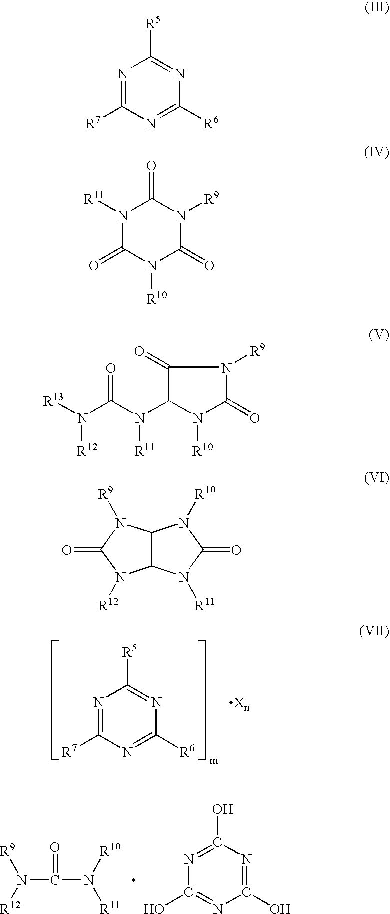
wherein
R⁵ to R⁷ are hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl, C₁-C₈-alkoxy, -acyl, -acyloxy, C₆-C₁₂-aryl or -arylalkyl, —OR⁸, or —N(R⁸)R⁹, including systems of alicyclic-N or aromatic-N type,
R⁸ is hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl, C₁-C₈-alkoxy, -acyl, -acyloxy, or C₆-C₁₂-aryl or -arylalkyl,
R⁹ to R¹³ are the same as R⁸, or —O—R⁸,
m and n, independently of one another, are 1, 2, 3, or 4,
X is an acid which forms adducts with triazine compounds (III).

16. The flame-retardant polymer molding composition as claimed in claim 9, wherein the at least one additive is a nitrogen compound selected from the group consisting of melamine, melamine condensates, melam, melem, melon; benzoguanamine, tris(hydroxyethyl) isocyanurate, allantoin, glycoluril, dicyandiamide, and guanidine.

17. The flame-retardant polymer molding composition as claimed in claim 9, wherein the at least one additive is melamine phosphate, dimelamine phosphate, melamine pyrophosphate, melamine polyphosphates, melam polyphosphates, melem polyphosphates, melon polyphosphates, melamine cyanurate, or urea cyanurate.

18. The flame-retardant polymer molding composition as claimed in claim 9, wherein the at least one additive is a zinc compound selected from the group consisting of zinc oxide, zinc hydroxide, zinc oxide hydrate, anhydrous zinc carbonate, basic zinc carbonate, zinc hydroxide carbonate, basic zinc carbonate hydrate, basic zinc silicate, zinc hexafluorosilicate, zinc stannate, zinc magnesium aluminum hydroxide carbonate, zinc hexafluorosilicate hexahydrate, zinc salts of the oxo acids of the third main group, zinc salts of the oxo acids of the fifth main group, zinc salts of the oxo acids of the transition metals, zinc chromite, zinc molybdate, zinc permanganate, zinc molybdate magnesium silicate, and zinc permanganate.

19. The flame-retardant polymer molding composition as claimed in claim 9, wherein the at least one additive is an antimony compound selected from the group consisting of antimony trioxide, antimony tetroxide, antimony pentoxide, sodium antimonate, and antimony tartrate.

20. The flame-retardant polymer molding composition as claimed in claim 9, wherein the at least one additive is selected from the group consisting of oligomeric esters of tris(hydroxyethyl) isocyanurate with aromatic polycarboxylic acids, carbodiimides, N,N′-dicyclohexylcarbodiimide, polyisocyanates, carbonylbiscaprolactam, styrene-acrylic polymers, sterically hindered phenols, and nitrogen-containing phosphates of the formulae (NH₄)_{y}H_{3-y}PO₄ or (NH₄PO₃)_{z}, where y is from 1 to 3, and z is from 1 to 10 000.

21. The flame-retardant polymer molding composition as claimed in claim 9, wherein the at least one additive is at least one compatibilizer.

22. The flame-retardant polymer molding composition as claimed in claim 21, wherein the at least one compatibilizer is an anhydride-modified oligomer or hydroxy-containing polyolefin oligomer.

23. The flame-retardant polymer molding composition as claimed in claim 1, wherein the flame-retardant polymer molding composition is a polybutylene terephthalate molding composition and wherein the SV numbers are from 750 to 1400.

24. The flame-retardant polymer molding composition as claimed in claim 1, further comprising nylon-6,6 and glass-fiber and wherein the MVR value is from 2 to 200 cm³/min (275° C., 5 kg).

25. The flame-retardant polymer molding composition as claimed in claim 1, having a residual moisture level from 0.01 to 10% by weight.

26. The flame-retardant polymer molding composition as claimed in claim 1, having a transparency from 70 to 100%.

27. A process for the preparation of a flame-retardant polymer molding composition as claimed in claim 1, comprising the step of dispersing the phosphorus-containing flame retardant system into the polymer molding composition or polymers in a compounding assembly.

28. A process for the preparation of a flame-retardant polymer molding composition as claimed in claim 1, comprising the step of dispersing the phosphorus-containing flame retardant system with the polymer molding composition in polymers in a compounding assembly.

29. The process as claimed in claim 27 further comprising the step of adding at least one composition selected from the group consisting of polymers, additives, auxiliaries, dispersing agents, and compatibilizers.

30. The process as claimed in claim 27, wherein the compounding assembly is selected from the group consisting of single-screw kneaders, twin-screw kneaders, co-kneaders, Brabender kneaders, calenders, roll mills, and triple-roll mills.

31. The process as claimed in claim 27, wherein the temperature is from 50 to 150° C., the reaction time is from 0.01 to 100 h, and the pressure is from 1 to 200 MPa.

32. The process as claimed in claim 27, further comprising the step of adding at least one compatibilzer in an amount of from 0.01 to 10% by weight based on the nanoparticulate phosphorus-containing flame retardant system.

33. The process as claimed in claim 32, wherein the at least one compatibilizer is selected from the group consisting of anhydride-modified oligomers, hydroxy-containing polyolefin oligomers, polyvinyl alcohol, polyethylene glycol, polytetrahydrofuran, polystyrene, polycaprolactone, organosilanes, and quaternary ammonium compounds.

34. The process as claimed in claim 27, wherein the processing temperatures are
from 170 to 200° C. when the at least one polymer is polystyrene,
from 200 to 300° C. when the at least one polymer is polypropylene,
from 250 to 290° C. when the at least one polymer is polyethylene terephthalate (PET),
from 230 to 270° C. when the at least one polymer is polybutylene terephthalate (PBT),
from 260 to 290° C. when the at least one polymer is nylon-6 (PA 6),
from 260 to 290° C. when the at least one polymer is nylon-6,6 (PA 6.6),
from 280 to 320° C. when the at least one polymer is polycarbonate.

35. The process as claimed in claim 34, wherein the L/D values for the compounding assembly are from 1 to 100.

36. The process as claimed in claim 27, wherein the shear rates for the compounding assembly are from 10 sec⁻¹ to 20 000 sec⁻¹.

37. A polymer article comprising a nanoparticulate phosphorus-containing flame retardant system comprising a polymer or a mixture of polymers and a phosphinic salt of the formula (I) a diphosphinic salt of the formula (II), a polymer of the phosphinic salt, a polymer of the diphosphinic salt or a mixture thereof, 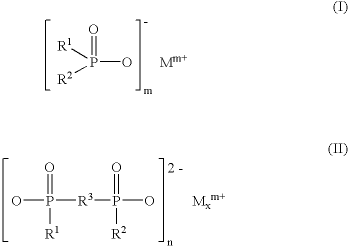
wherein
R¹ and R² are identical or different and are C₁-C₆-alkyl, linear or branched, or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Fe, Zr, Zn, Ce, Bi, Sr, Mn, Li, Na, K, or a protonated nitrogen base;
m is from 1 to 4;
n is from 1 to 4;
x is from 1 to 4
wherein the polymer article is selected from the group consisting of a polymer molding, polymer film, polymer filament and polymer fiber.

38. The polymer article as claimed in claim 37, comprising:
from 0.5 to 45% by weight of the nanoparticulate phosphorus-containing flame retardant system,
from 0.5 to 95% by weight of the polymer or the mixture of polymers.

39. The polymer article as claimed in claim 37 comprising:
from 0.5 to 45% by weight of the nanoparticulate phosphorus-containing flame retardant system,
from 0.5 to 95% by weight of the polymer or the mixture of polymers,
from 0.5 to 55% by weight of at least one additive,
from 0.5 to 55% by weight of at least one of a filler or reinforcing material.

40. The polymer article as claimed in claim 39, comprising
from 10 to 40% by weight of the nanoparticulate phosphorus-containing flame retardant system,
from 10 to 80% by weight of the polymer or the mixture of polymers,
from 2 to 40% by weight of at least one additive,
from 2 to 40% by weight of at least one of a filler or reinforcing material.

41. A polymer article comprising a flame-retardant polymer molding composition as claimed in claim 1, wherein the polymer article is selected from the group consisting of a polymer molding, polymer film, polymer filament and polymer fiber.

42. The polymer article as claimed in claim 40, comprising:
from 60 to 98% by weight of the flame-retardant polymer molding composition,
from 1 to 40% by weight of the polymer or the mixture of polymers.

43. The polymer article as claimed in claim 42, which comprises
from 60 to 98% by weight of the flame-retardant polymer molding composition,
from 1 to 40% by weight of the polymer or the mixture of polymers,
from 0.2 to 40% by weight of at least one additive,
from 0.2 to 40% by weight of at least one of a filler or reinforcing material.

44. The polymer article as claimed in claim 37, wherein the polymer is polybutylene terephthalate nylon-6,6 or nylon-6 and wherein the modulus of elasticity is from 10 000 to 12 000 MPa.

45. The polymer article as claimed in claim 37, wherein the UL 94 classification of the polymer article is V-1 or V-0.

46. The polymer article as claimed in claim 37, wherein the polymer is polybutylene terephthalate and wherein the tensile strain at break is from 1.3 to 3%.

47. The polymer article as claimed in claim 37, wherein the polymer is polybutylene terephthalate and wherein the impact resistance is from 45 to 70 KJ/m².

48. The polymer article as claimed in claim 37, wherein the polymer is polybutylene terephthalate and the glow-wire temperature, measured by the glow-wire ignition test, is from 750 to 900° C.

49. The polymer article as claimed in claim 37, having a transparency from 70 to 100%.

50. The polymer article as claimed in claim 37, wherein the particle size of the nanoparticulate phosphorus-containing flame retardant system is from 1 to 1000 nm.

51. A process for the production of the polymer article as claimed in claim 37, comprising the step of injection molding polymer article.

52. The process as claimed in claim 51, wherein the processing temperatures are
from 200 to 250° C. when the polymer is polystyrene,
from 200 to 300° C. when the polymer is polypropylene,
from 250 to 290° C. when the polymer is polyethylene terephthalate (PET),
from 230 to 270° C. when the polymer is polybutylene terephthalate (PBT),
from 260 to 290° C. when the Polymer is nylon-6 (PA 6),
from 260 to 290° C. when the polymer is nylon-6,6 (PA 6.6),
from 280 to 320° C. when the polymer is polycarbonate.

53. The flame-retardant polymer molding composition as claimed in claim 1, wherein the particle size of the nanoparticulate phosphorus-containing flame retardant system is from 5 to 500 nm.

54. The flame-retardant polymer molding composition as claimed in claim 1, wherein the BET surface area of the nanoparticulate phosphorus-containing flame retardant system is from 5 to 500 m²/g.

55. The flame-retardant polymer molding composition as claimed in claim 21, wherein the at least one compatibilizer is polypropylene-maleic anhydride copolymer, polyvinylpyrrolidone, polyvinyl alcohol, polyethylene glycol, polytetrahydrofuran, polystyrene, polycaprolactone, an organosilane or a quaternary ammonium compound.

56. The flame-retardant polymer molding composition as claimed in claim 1, wherein the flame-retardant polymer molding composition is a polybutylene terephthalate molding composition and wherein the SV numbers are from 950 to 1300.

57. The flame-retardant polymer molding composition as claimed in claim 1, wherein the flame-retardant polymer molding composition is a polybutylene terephthalate molding composition and wherein the SV numbers are from 1000 to 1200.

58. The flame-retardant polymer molding composition as claimed in claim 1, further comprising a residual moisture level from 0.1 to 1% by weight.

59. The process as claimed in claim 27, further comprising the step of adding at least one compatibilzer in amount of from 1 to 5% by weight based on the nanoparticulate phosphorus-containing flame retardant system.

60. The process as claimed in claim 34, wherein the L/D values for the compounding assembly are from 2 to 50.

61. The process as claimed in claim 27, wherein the shear rates for the compounding assembly are from 100 sec⁻¹ to 10 000 sec⁻¹.

62. The polymer article as claimed in claim 37, wherein the polymer is polybutylene terephthalate and wherein the tensile strain at break is from 1.9 to 2.2%.

63. The polymer article as claimed in claim 37, wherein the polymer is polybutylene terephthalate and wherein the impact resistance is from 55 to 62 kJ/m².

64. The polymer article as claimed in claim 37, wherein the polymer is polybutylene terephthalate and the glow-wire temperature, measured by the glow-wire ignition test, is from 775 to 875° C.

65. The polymer article as claimed in claim 37, wherein the particle size of the nanoparticulate phosphorus-containing flame retardant system is from 5 to 500 nm.

66. The polymer article as claimed in claim 37, wherein the BET surface area of the nanoparticulate phosphorus-containing flame retardant system is from 2 to 1000 m²/g.

67. The polymer article as claimed in claim 37, wherein the BET surface area of the nanoparticulate phosphorus-containing flame retardant system is from 5 to 500 m²/g.

68. The polymer article as claimed in claim 37, wherein the nanoparticulate phosphorus-containing flame retardant system comprises from 0.01 to 10% by weight of at least one of a protective colloid or crystallization modifier.
